(19) United States
(12) Patent Application Publication
(10) Pub. No.: US 2025/0117735 A1
(43) Pub. Date: Apr. 10, 2025

(54) CONTROLLING THE PHYSICAL DELIVERY OF OBJECTS TO A USER AT A PROPERTY

(71) Applicant: S10S LLC, Northfield, IL (US)

(72) Inventor: Timothy Halfmann, Northfield, IL (US)

(21) Appl. No.: 18/908,297

(22) Filed: Oct. 7, 2024

Related U.S. Application Data
(60) Provisional application No. 63/542,967, filed on Oct. 6, 2023.

(51) Int. Cl. G06Q 10/083; G06K 7/14

(52) U.S. Cl. CPC G06Q 10/083; G06K 7/1417

(57) ABSTRACT

This method leverages a system to manage the process of accepting and verifying unique codes associated with physical objects, displaying delivery options to the user, accepting user inputs related to future deliveries, storing these inputs, and communicating them to the relevant senders.

### CROSS-REFERENCE TO RELATED APPLICATIONS:

This application claims the benefit of U.S. Provisional Application No. 63/542,967, entitled “METHOD TO CONTROL THE PHYSICAL DELIVERY OF OBJECTS TO A USER AT A PROPERTY”, filed Oct. 6, 2023, reference of which is hereby incorporated herein in its entirety.

### BACKGROUND

Unrequested mail wastes paper and time for people that do not desire the mail. Users have to take time to scan the mail and then dispose of the mail where it fills landfills. At the same time, there may be people that enjoy and use unrequested mail. The discounts offered may be useful and the user may learn about goods or services that may be new to them. It may be useful to have a system to allow users to opt in or opt out of unrequested mail that is simple to use.

### SUMMARY

The present system and method efficiently controls the physical delivery of objects to a user at a property. This method leverages a system (100) to manage the process of accepting and verifying unique codes associated with physical objects, displaying delivery options to the user, accepting user inputs related to future deliveries, storing these inputs, and communicating them to the relevant senders.

### BRIEF DESCRIPTION OF THE DRAWINGS

FIG. 1 may illustrate blocks executed by the system;

FIG. 2 may illustrate some physical elements in the system;

FIG. 3 may illustrate a method using user or address preferences to create opt in or opt out lists;

FIG. 4 may illustrate a method of using a large language model to predict addresses; and

FIG. 5 may illustrate a method of using digital twins.

Persons of ordinary skill in the art will appreciate that elements in the figures are illustrated for simplicity and clarity so not all connections and options have been shown to avoid obscuring the inventive aspects. For example, common but well-understood elements that are useful or necessary in a commercially feasible embodiment are not often depicted in order to facilitate a less obstructed view of these various embodiments of the present disclosure. It will be further appreciated that certain actions and/or steps may be described or depicted in a particular order of occurrence while those skilled in the art will understand that such specificity with respect to sequence is not actually required. It will also be understood that the terms and expressions used herein are to be defined with respect to their corresponding respective areas of inquiry and study except where specific meanings have otherwise been set forth herein. All dimensions specified in this disclosure may be by way of example only and are not intended to be limiting. Further, the proportions shown in these Figures may not be necessarily to scale. As will be understood, the actual dimensions and proportions of any system, any device or part of a system or device disclosed in this disclosure may be determined by its intended use.

### DETAILED DESCRIPTION

Unrequested mail wastes paper and time for people that do not desire the mail. Users have to take time to scan the mail and then dispose of the mail where it fills landfills. At the same time, there may be people that enjoy and use unrequested mail. The discounts offered may be useful and the user may learn about goods or services that may be new to them. It may be useful to have a system to allow users to opt in or opt out of unrequested mail that is simple to use.

The present system and method may efficiently control the physical delivery of objects to a user at a property. This method may leverage a system (100) to manage the process of accepting and verifying unique codes associated with physical objects, displaying delivery options to the user, accepting user inputs related to future deliveries, storing these inputs, and communicating them to the relevant senders.

Methods and devices that may implement the embodiments of the various features of the invention will now be described with reference to the drawings. The drawings and the associated descriptions may be provided to illustrate embodiments of the invention and not to limit the scope of the invention. Reference in the specification to “one embodiment” or “an embodiment” may be intended to indicate that a particular feature, structure, or characteristic described in connection with the embodiment may be included in at least an embodiment of the invention. The appearances of the phrase “in one embodiment” or “an embodiment” in various places in the specification may not necessarily be referring to the same embodiment.

Throughout the drawings, reference numbers may be re-used to indicate correspondence between referenced elements. As used in this disclosure, except where the context requires otherwise, the term “comprise” and variations of the term, such as “comprising”, “comprises” and “comprised” may not be intended to exclude other additives, components, integers or steps.

In the following description, specific details may be given to provide a thorough understanding of the embodiments. However, it may be understood by one of ordinary skill in the art that the embodiments may be practiced without these specific details. Well-known circuits, structures and techniques may not be shown in detail in order not to obscure the embodiments. For example, circuits may be shown in block diagrams in order not to obscure the embodiments in unnecessary detail.

Also, it is noted that the embodiments may be described as a process that is depicted as a flowchart, a flow diagram, a structure diagram, or a block diagram. The flowcharts and block diagrams in the figures may illustrate the architecture, functionality, and operation of possible implementations of systems, methods and computer programs according to various embodiments disclosed. In this regard, each block in the flowchart or block diagrams may represent a module, segment, or portion of code, that may include one or more executable instructions for implementing the specified logical function(s). It should also be noted that, in some alternative implementations, the functions noted in the blocks may occur out of the order noted in the figures.

Although a flowchart may describe the operations as a sequential process, many of the operations may be performed in parallel or concurrently. In addition, the order of the operations may be rearranged. A process may be terminated when its operations are completed. A process may correspond to a method, a function, a procedure, a subroutine, a subprogram, etc. When a process corresponds to a function, its termination may correspond to a return of the function to the calling function or the main function. Additionally, each block of the block diagrams and/or flowchart illustration, and combinations of blocks in the block diagrams and/or flowchart illustration, may be implemented by special purpose hardware-based systems that perform the specified functions or acts, or combinations of special purpose hardware and computer instructions.

Moreover, a storage may represent one or more devices for storing data, including read-only memory (ROM), random access memory (RAM), magnetic disk storage mediums, optical storage mediums, flash memory devices and/or other non-transitory machine-readable mediums for storing information. The term “machine readable medium” may include but is not limited to portable or fixed storage devices, optical storage devices, wireless channels and various other non-transitory mediums capable of storing, comprising, containing, executing or carrying instruction(s) and/or data.

Furthermore, embodiments may be implemented by hardware, software, firmware, middleware, microcode, or a combination thereof. When implemented in software, firmware, middleware or microcode, the program code or code segments to perform the necessary tasks may be stored in a machine-readable medium such as a storage medium or other storage(s). One or more than one processor may perform the necessary tasks in series, distributed, concurrently or in parallel. A code segment may represent a procedure, a function, a subprogram, a program, a routine, a subroutine, a module, a software package, a class, or a combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted through a suitable means including memory sharing, message passing, token passing, network transmission, etc. and are also referred to as an interface, where the interface is the point of interaction with software, or computer hardware, or with peripheral devices.

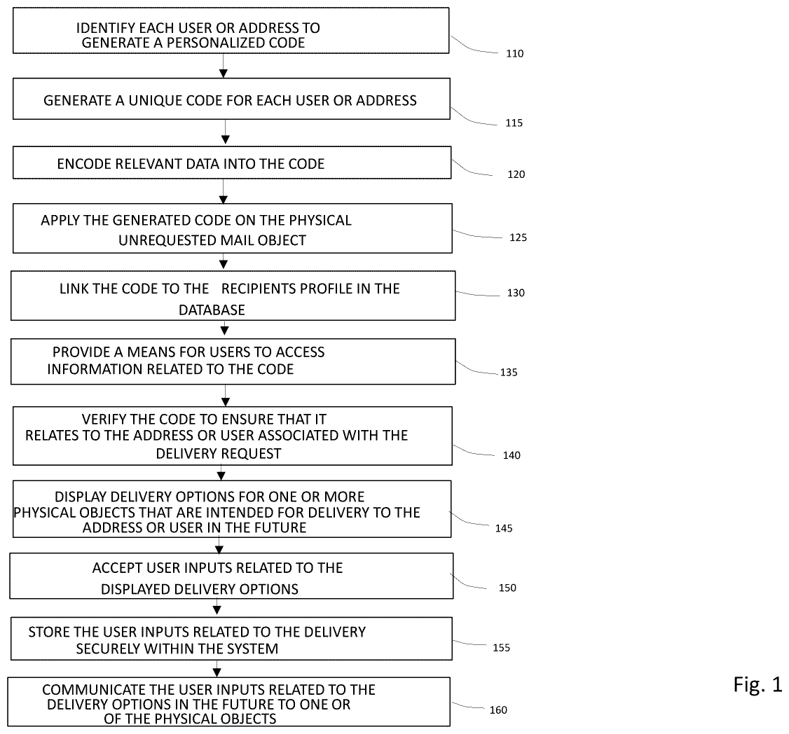

A system and method for controlling physical object deliveries may be broken down into several blocks, each supported by reference numbers. Referring to FIG. 1, a unique code such as a QR code specific to a user or address may be created that may be placed on unrequested mail objects.

### 1. User Identification

At block 110, the system may accurately identify each user or address to generate a personalized code. This identification may be based on a user's unique ID, address, or any other identifier specific to the system.

### 2. Code Generation

At block 115, a unique code such as a multi-character or digit code or bar code or QR code may be generated for each user or address. There may be various libraries and tools available for generating codes programmatically. Examples may include Python libraries like qrcode or online code generators with APIs.

The data to be encoded may include:
Address Information;
Street number;
Street name;
City;
State; and
ZIP code.
Unique Identifiers may also be useful for each item.
Date/time of generation or dispatch; and
Check Digits/Validation:

A check digit may be used to ensure the accuracy of the code (to detect errors in the code, like mistyped digits)

### 3. Data Encoding

At block 120, relevant data may be encoded into the code. This data may include the user's unique identifier, delivery instructions, preferences, or any other information that may be desired to associate with the recipient. One possible set of steps to encode address information is described.
ZIP Code: Start by using the ZIP+4 code to localize to a specific area (ZIP+4 narrows the location down to a segment of a street).
House Number and Street: Convert the house number and street into numerical format. Unique numeric codes may be assigned to streets within each ZIP+4 area. House numbers may be directly encoded or reduced into fewer digits using mathematical transformations or compression methods.
City and State: Each city and state may already have postal codes. The codes may be encoded into short alphanumeric representations.
Unique Sequence Number: To distinguish between different pieces of mail sent to the same address, a unique sequence number or timestamp may be added.
Error Detection (Optional): A checksum or error-detecting mechanism like a check digit may be added to ensure the code's validity.

### Example Code Structure:

Let's say a 12-character alphanumeric code may be used for tracking mail. One way to break down the code may be:
Characters 1-5: ZIP+4 code
Characters 6-9: Encoded house number and street
Character 10-11: Encoded city and state
Character 12: Checksum or unique identifier for the specific mail item
   For example:
ZIP+4:90210-1234→Encodes as 90210
House number 101, street Main St→Encodes as 5A3D
City Beverly Hills, State CA→Encodes as 1C
Checksum: X

The full code could look like: 902105A3D1CX.

There may be a variety of ways of encoding the code: One way is base conversion: Numerical values may be converted (e.g., house numbers, ZIP codes) to a different base (like Base32 or Base64) to reduce the number of characters.

Hashing is another way to encode the code: A cryptographic hash function (like SHA-256) may be used to create a unique, compact representation of the address. Hashing may be useful if there is a desire to obscure specific address details.

Concatenation & Compression is another approach to encode the code: If the code needs to be smaller, parts of the data may be combined, and a compression algorithm may be used to shrink the total size.

### 4. Printing on Mail Object

At block 125, the generated code may be applied on the physical unrequested mail object. This may be done using printing technology that allows for precise placement of codes on mail items. More detail on affixing the code may be described in a later section.

### 5. Database Integration

At block 130, the code may be linked to the recipient's profile in the database. This linkage may enable tracking and management of the mail object and may ensure that the code may be associated with the correct recipient.

In some embodiments, there may be multiple providers of mail objects. The multiple providers may combine their mail objects into single packets or packages to case delivery. The codes on the objects may also indicate which of the multiple suppliers is the source of the specific mail object.

### 6. User Access to Information

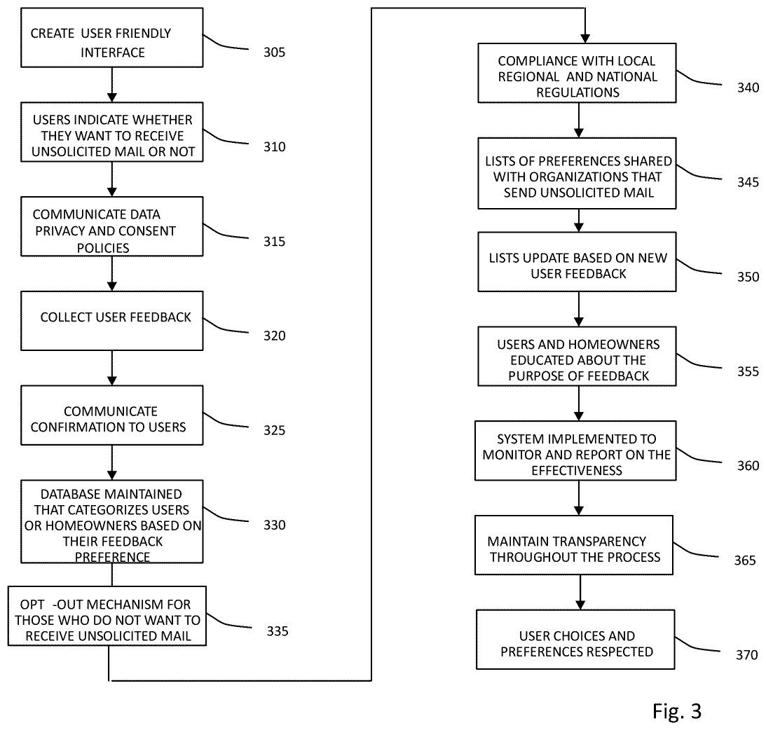

At block 135, a means or device may be provided for users to access information related to the code. This may be done by instructing users to scan the code using a code scanner app on their mobile devices or by providing a web link associated with the code. Further options on scanning the code may be described in relation to FIG. 3.

### 7. Customized Content (Optional)

If desired, the system may link the code to customized content or actions specific to the recipient. For example, the code might lead the user to a personalized landing page with additional information or options to further specify their preferences.

### 8. User Interaction

Encourage users to interact with the code by offering incentives or benefits, such as access to exclusive content, discounts, or options to modify their delivery preferences.

### 9. Feedback and Tracking

The code may be a means to gather feedback from users. The system may track how often users interact with the code and whether they choose to opt-in or opt-out of receiving future unrequested mail.

### 10. Privacy and Data Security

The system may ensure that user data encoded in the code may be handled securely and in compliance with data protection regulations.

### Label Creation

In some embodiments, placing a unique code on physical mail items may be achieved using various printing and labeling methods. The specific method chosen may depend on the volume of mail, the level of personalization required, and your budget. Here may be some common methods:

### 1. Label Printing

Use label printers to generate code labels that may be affixed to each mail item. This approach may be suitable for relatively low-volume mailings and allows for easy customization.

### 2. Direct Printing

If there is a higher volume of mail and a more integrated look is desired, a direct printing method may be used. Codes may be printed directly onto the mail piece using specialized printers or print shops equipped for variable data printing.

### 3. Stickers or Decals

For small-scale mailings or for adding codes to packages or parcels, code stickers or decals may be created that may be manually applied to each item.

### 4. Customized Mail Services

Some mailing services and companies offer customized mail services that may print and affix codes to mail items as part of their services. This may be a convenient option for larger mailings.

### 5. Inkjet Printing

High-speed inkjet printers may be used to print codes directly onto envelopes or other mail materials as they pass through the printing process. This may be a common method for high-volume mailings.

### 6. Label Applicators

Label applicators may be machines that may automatically apply labels, including code labels, to mail items at a rapid pace. This may be often used in industrial settings for large-scale mailings.

### 7. Code Integration

In some cases, codes may be integrated into the design of the mail piece itself during the printing process. For example, the code may be printed as part of a graphic or design element on the envelope or packaging.

### 8. Hybrid Methods

Depending on the needs, a combination of methods may be used. For instance, codes may be printed directly onto envelopes for high-volume mailings and use label printers for lower-volume, personalized mailings.

### 9. Quality Control

Regardless of the method used, quality control measures may be implemented to ensure that codes may be printed accurately, may be scannable, and match the intended recipient. When implementing codes on physical mail, it may be important to consider factors such as the type of mail item, the volume of mailings, and the level of personalization required. Additionally, the system may ensure that the codes may be well-placed, easily scannable, and securely affixed to the mail items to provide a seamless and effective user experience.

### Scanning The Code

Scanning a unique code, such as a QR code, by a user typically involves using a mobile device with a built-in camera and a code scanning application. Here may be the general steps for a user to scan a unique code:

### 1. Mobile Device

The user may use a smartphone or tablet with a camera. Most modern smartphones come equipped with built-in cameras.

### 2. Code Scanning App

The user may download a code scanning application from their device's app store. These apps may be available for both iOS and Android devices. In some embodiments, the application may be preloaded and may start automatically when the camera determines a code is in view.

### 3. Open the Scanning App

The code scanning app may be launched on the mobile device. The app typically provides a camera viewfinder to capture the code.

### 4. Focus on the Code

The mobile device's camera may be positioned so that it may clearly see and focus on the code. The user may need to adjust the distance and angle to ensure a clear view of the code.

### 5. Scan the Code

Once the code is within the camera's view, the scanning app may automatically detect and scan the code. It may make a sound or display a visual confirmation when successful. As mentioned previously, in some embodiments, the application may be preloaded and may start automatically when the camera determines a code is in view.

### 6. Interpretation

The scanning app may interpret the information encoded in the code. This may be a URL, text, contact information, or any other data that the code represents.

### 7. Action

Depending on the content of the code, the scanning app may perform various actions, such as opening a web link in the device's browser, displaying text, adding a contact to the phone's address book, or executing other relevant actions.

### 8. User Interaction

The user may then interact with the scanned content based on the app's capabilities. For example, if the code represents a web link, the user may navigate to the linked website.

### 9. Privacy and Security

The scanning app and any associated actions may respect user privacy and data security. Users may be aware of what information they may be sharing or accessing via the code.

Overall, scanning a unique code by a user may be a straightforward process that involves using a code scanning app on a mobile device. It allows users to interact with encoded information and take relevant actions based on the content of the code.

Referring again to FIG. 1, at block 140, the code may be subjected to verification to ensure that it indeed relates to the address or user associated with the delivery request. Verification may involve cross-referencing the code with a database of authorized codes and addresses.

Logically, the encoded code may have to be decoded at an authority that sends the communications to assist in verification. When decoding the encoded code, the system may follow a systematic approach based on the encoding structure.

The decoder may first extract the ZIP+4 code from the encoded string. If the first five characters represent the ZIP code, followed by the next four characters for the extension, one may directly map these to a postal area. This helps narrow down the location to a specific region or street segment.

The next portion of the code, which could be a block of characters (e.g., characters 6 to 9), may represent the house number and street. The decoder may use a reverse lookup table or a specific mathematical transformation to map these characters back to the original house number and street name. If a base conversion or compression technique was used, one may need to apply the reverse process to retrieve the original values.

The following characters (e.g., characters 10 and 11) may correspond to the city and state. One may reference an internal mapping table, where each code corresponds to a specific city and state pair. The decoder may look up the alphanumeric code and retrieve the original city and state.

If a checksum was used, the final character in the code may serve as an error-detecting mechanism. The decoder may calculate the checksum based on the decoded address components and compare it to the checksum in the code. If the checksums match, the decoded data is likely correct. If they don't, the decoder may flag the code as invalid or containing errors.

In some cases, a unique sequence number or timestamp may be included to distinguish different pieces of mail sent to the same address. The decoder may extract and store this information separately to help track or timestamp the mail.

By following this process, one may effectively decode the tracking code and retrieve the full address and associated details. The decoding method may vary slightly depending on the specific encoding strategy chosen, such as the base used for conversion, or the compression method applied.

Once decoded, if the address is not recognized or the checksum is wrong or the timestamp is incorrect, an error may be displayed, and the method may end until the error is corrected.

### Step 2—Display of Delivery Options:

After successful verification, at block 145, the system may proceed to display delivery options for one or more physical objects that may be intended for delivery to the address or user in the future. These options may be presented through a User Interface (110) to facilitate user selection.

### Step 3—User Input and Storage:

At block 150, the system may accept user inputs related to the displayed delivery options. Users may make choices regarding the timing, delivery preferences, and any specific instructions related to the future delivery such as stop, send more, send similar, send less, etc. These inputs may be collected through the User Interface (110).

155: The user inputs related to the delivery options in the future may be stored securely within the system, ensuring that the user's preferences and instructions may be retained for future reference.

### Step 4—Communication to Senders:

At block 160, the system's communication module may be responsible for transmitting the user inputs related to the delivery options in the future to one or more senders of the physical objects. This communication may facilitate coordination between the user and the senders, ensuring that the delivery process aligns with the user's preferences and instructions.

The described method for controlling the physical delivery of objects to a user at a property offers a streamlined and user-centric approach to managing deliveries. By accepting, verifying, displaying options, collecting user inputs, and communicating those inputs to senders, this method enhances the overall delivery experience, providing convenience and efficiency to both users and senders.

### Hardware Be Components

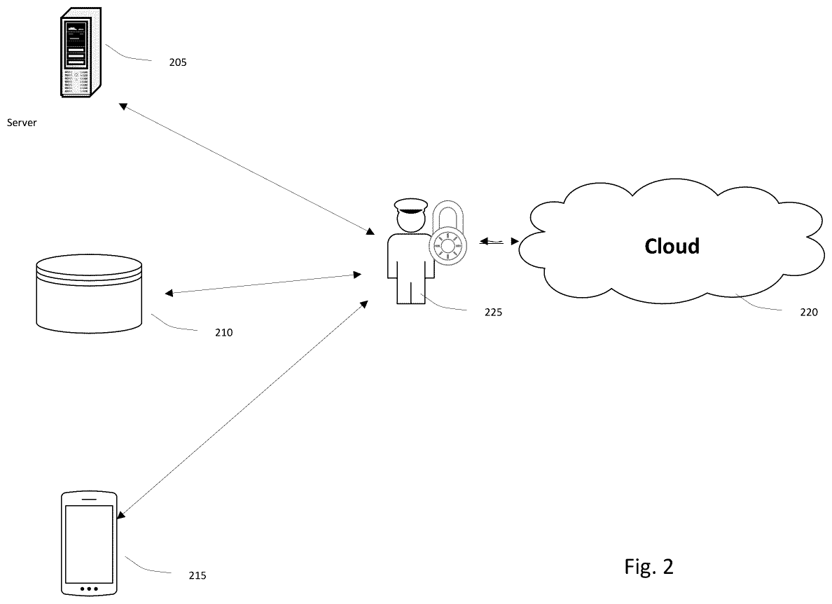

Referring briefly to FIG. 2, there may be several physical elements which may up the infrastructure of the system.

### Server Infrastructure 205

A robust server infrastructure may be necessary to host the software be components and databases required for the system.

### Database System 210

A database system may be needed to store information about unique codes, user profiles, delivery options, and user inputs. This database may support efficient retrieval and storage of data.

### User Interface Devices 215

User Interface (UI) devices such as smartphones, tablets, or web browsers may be used for user interaction. These devices enable users to input unique codes, make delivery choices, and view delivery options.

### Communication Infrastructure 220

To facilitate communication with users and senders, the system requires internet connectivity and email or messaging services.

### Security Measures 225

Robust security measures, including encryption and access controls, may be in place to protect user data and ensure the integrity of the system.

### Software Be Components

### Verification Algorithms

Verification algorithms may be essential to validate whether the unique code provided by the sender matches the address or user associated with the delivery request. This may involve comparing codes to a reference database.

### User Interface Software

User interface software may be responsible for presenting delivery options to users, accepting user inputs, and displaying relevant information. This may be implemented as a web application or mobile app.

### Database Management System (DBMS)

A DBMS may be used to manage the storage and retrieval of data from the database system. Common choices include MySQL, PostgreSQL, or NoSQL databases depending on the specific requirements.

### Communication Modules

Communication modules handle the transmission of user inputs to senders and may include email or messaging integrations. These modules ensure seamless communication between the system and external parties.

### Security Software

Security software includes firewalls, intrusion detection systems, and encryption protocols to safeguard sensitive user data.

### Data Storage and Retrieval Components

These components manage the storage and retrieval of user inputs, delivery preferences, and associated data within the database.

### Algorithm for Delivery Options

An algorithmic component may be required to generate and present delivery options based on user preferences, delivery schedules, and sender capabilities.

### Networking and Connectivity

High-speed internet connectivity may be essential for real-time communication between the system, users, and senders. This enables efficient data exchange and ensures timely updates on delivery options and user inputs.

### Scalability and Redundancy

The computing structure may be designed to scale horizontally to accommodate increased user demand. Redundancy measures, such as load balancing and failover systems, may ensure high availability.

### Data Backup and Recovery

Regular data backups and a robust disaster recovery plan may be in place to prevent data loss and minimize downtime.

### Cloud Services (Optional)

To enhance scalability and reduce infrastructure costs, cloud services like AWS, Azure, or Google Cloud may be utilized to host the system's components.

Logically, all these software elements may be embodied in separate physical elements which are specifically designed to execute the various software elements. For example, there may be a verification server, a user interface generating server, security server, etc. The servers may be physically separate or may be combined onto one or more servers where the servers are adapted to maximize the services in question.

In summary, the computing structure for enabling the described method may include server infrastructure, a database system, user interface devices, communication infrastructure, security measures, and various software be components. These elements work together to create a secure, efficient, and user-friendly system for controlling the physical delivery of objects to users at their properties.

### Creating Lists

Collecting responses from users or homes to create lists of those who desire unrequested mail (commonly referred to as “junk mail” or “unsolicited mail”) and those who do not desire it involves implementing a feedback system and respecting user preferences. FIG. 3 may illustrate a step-by-step guide on how these lists may be created:

### 1. User Interface for Feedback

At block 305, a user-friendly interface may be created, such as a website, mobile app, or physical mail-in form, where users or homeowners may provide their feedback regarding unsolicited mail.

### 2. Feedback Options

At block 310, feedback options may be created that are clear and simple. Users may be able to indicate whether they want to receive unsolicited mail or opt-out. Options may include:

“I want to receive unsolicited mail.”

“I do not want to receive unsolicited mail.”

### 3. Privacy and Consent

At block 315, data privacy and consent policies may be clearly communicated. Ensuring that users understand how their information may be used and that their preferences may be respected may be necessary.

### 4. Data Collection

At block 320, user feedback may be collected and stored in a secure and organized manner. Each response may be associated with the user's or homeowner's contact information and their feedback preference.

### 5. Confirmation

At block 325, in some embodiments, a confirmation email or mail may be communicated to users or homeowners after they submit their feedback to confirm their preference and provide them with a record of their choice.

### 6. Database Management

At block 330, a well-organized database may be maintained that categorizes users or homeowners based on their feedback preference. Separate lists may be created for those who desire unsolicited mail and those who do not.

### 7. Opt-Out Mechanism

At block 335, a straightforward opt-out mechanism for those who do not want to receive unsolicited mail may be instituted. A clear and easy way for users to update their preferences or opt-out at any time may be provided.

### 8. Compliance with Regulations

At block 340, compliance with local, regional, and national regulations may be necessary regarding unsolicited mail, including opt-out requirements.

### 9. Communication with Mailers

At block 345, the lists of preferences may be shared with organizations and businesses that send unsolicited mail. Mailers may be informed about who wishes to receive their mail and who does not.

### 10. Regular Updates

At block 350, lists may be continuously update based on new user feedback. Opt in and opt out data may be regularly communicated with mailers to ensure they have the most up-to-date information.

### 11. User Education

At block 355, users and homeowners may be educated about the purpose and benefits of providing feedback on unsolicited mail which may encourage them to share their preferences to reduce unwanted mail.

### 12. Monitoring and Reporting

A block 360, the system may be implemented to monitor and report on the effectiveness of the feedback mechanism. The number of users who opt-in or opt-out may be tracked and use this data may be used to refine the approach.

### 13. Transparency

At block 365, transparency may be maintained throughout the process. How user preferences may be used and respected may be clearly communicated, and channels may be provided for users to reach out with questions or concerns.

### 14. Respect User Choices

At block 370, above all, user choices and preferences may be respected. Opt-out requests may be honored promptly, and the system may ensure that users who wish to receive unsolicited mail continue to receive it.

Logically, all these software elements may be embodied in separate physical elements which are specifically designed to execute the various software elements. For example, there may be servers for each function specifically designed for each function. The servers may be physically separate or may be combined onto one or more servers where the servers are adapted to maximize the services in question.

### Large Language Model

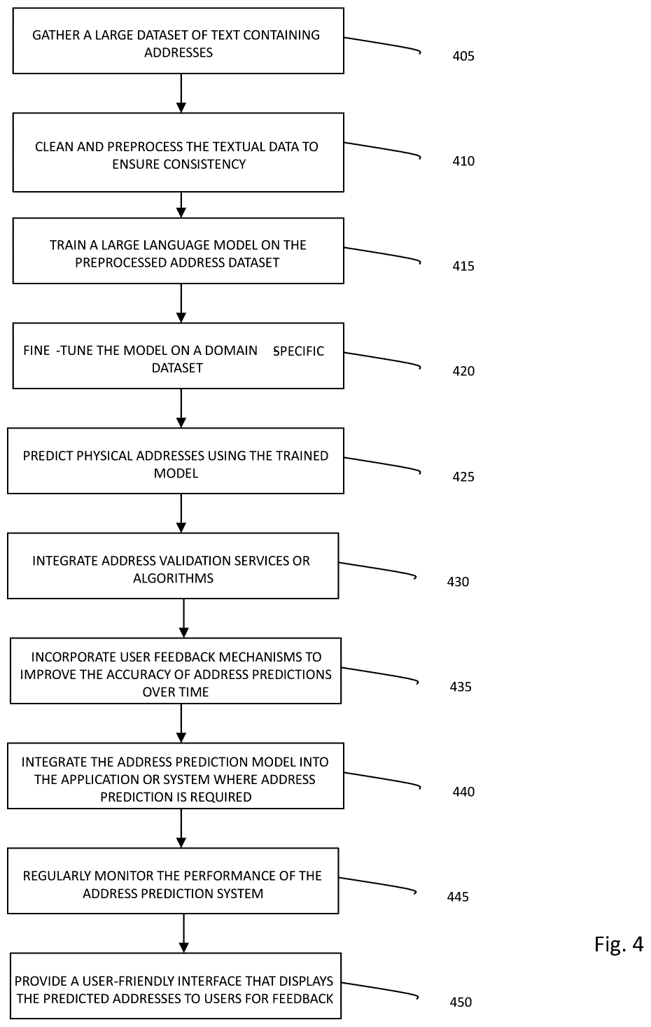

A large language model may be used to help predict physical addresses. The large language model may be achieved by training the model on a dataset of textual information containing addresses or by using it as part of an address verification and validation system. FIG. 4 may illustrate one way of creating the model.

### 1. Data Collection

At block 405, the system may gather a large dataset of text containing addresses. This dataset may ideally cover a wide range of addresses, including different formats, languages, and regions.

### 2. Preprocessing

At block 410, the system may clean and preprocess the textual data to ensure consistency. This may involve removing special characters, standardizing formatting, and tokenizing the text into individual words or components.

### 3. Training

At block 415, the system may train a large language model, such as GPT-3 or similar models, on the preprocessed address dataset. The model may learn the patterns and structures of addresses from the training data.

### 4. Fine-Tuning (Optional)

At block 420, the system may, depending on the specific requirements of the address prediction application, fine-tuning the model on a domain-specific dataset. For example, if you're predicting business addresses, fine-tuning on business-related text may improve accuracy.

### 5. Address Prediction

At block 425, the system may predict physical addresses using the trained model, the method may follow these steps:

Input Text: Provide a query or input text to the model, which may contain partial or incomplete address information. For example, “123 Main St” or “City, Country.”

Model Inference: Feed the input text into the trained language model, which may use its learned knowledge to generate predictions based on the patterns it has learned from the training data.

Output: The model may generate a predicted address or a completion for the input text, such as “123 Main St, Anytown, USA.” This output may be used as a suggested or completed address.

### 6. Address Validation (Optional)

At block 430, the system may, to ensure the accuracy and validity of the predicted address, integrate address validation services or algorithms. These services may verify whether the predicted address may be a valid, deliverable address according to postal standards.

### 7. User Feedback (Optional)

At block 435, the system may incorporate user feedback mechanisms to improve the accuracy of address predictions over time. Users may confirm or correct the predicted addresses, helping to refine the model's performance.

### 8. Application Integration

At block 440, the system may integrate the address prediction model into the application or system where address prediction may be required. This may be in e-commerce platforms, delivery services, or any application that involves address entry.

### 9. Continuous Monitoring and Updates

At block 445, the system may regularly monitor the performance of the address prediction system and update the model as needed to adapt to changing patterns or new address formats.

### 10. User Interface

At block 450, the system may provide a user-friendly interface that displays the predicted addresses to users and allows them to confirm or edit the predictions before finalizing.

While large language models may be effective at predicting addresses, they may be not a replacement for address validation services, especially when precise and validated addresses may be critical, such as in shipping and logistics applications. Combining language models with address validation checks may provide a robust solution for address prediction.

Logically, all these software elements may be embodied in separate physical elements which are specifically designed to execute the various software elements. For example, there may be servers for each function specifically designed for each function. The servers may be physically separate or may be combined onto one or more servers where the servers are adapted to maximize the services in question.

### Digital Twins

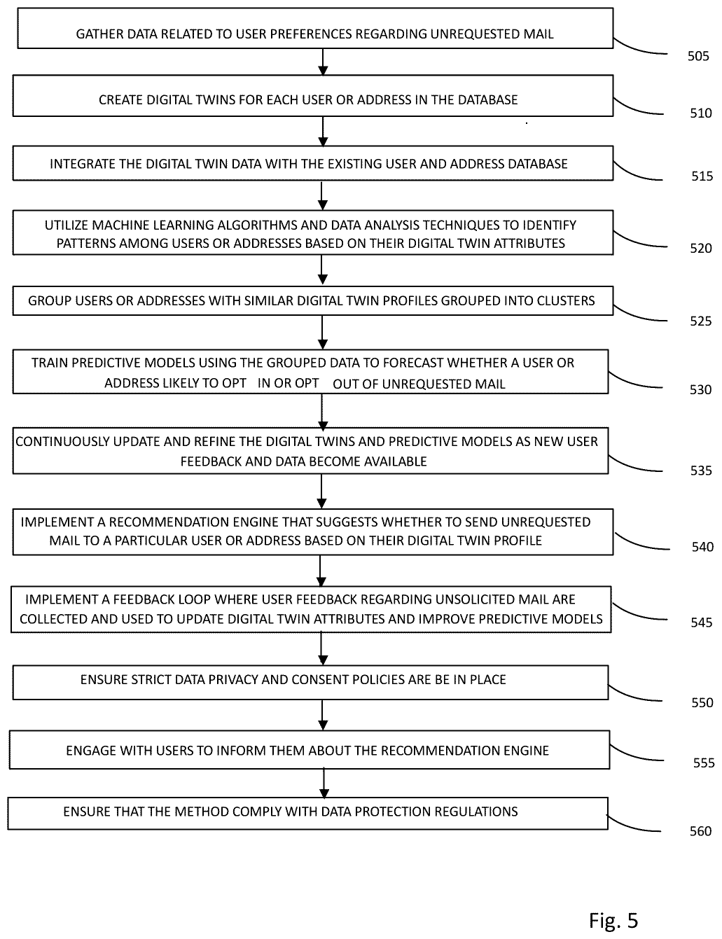

Leveraging the concept of a digital twin to identify users or addresses with similar desires to opt-in or opt-out of unrequested mail involves creating a virtual representation of the users or addresses and applying data analytics and machine learning techniques. FIG. 5 may illustrate one way to use the digital twin approach:

### 1. Data Collection

At block 505, the method may gather data related to user preferences regarding unrequested mail. This data may include historical user feedback, user demographics, geographic location, previous interactions with unsolicited mail, and any other relevant information.

### 2. Digital Twin Creation

At block 510, the method may create digital twins for each user or address in the database. A digital twin may be a virtual representation that mirrors the real-world entity, in this case, the user or address. Each digital twin may include attributes such as age, location, past feedback, and current preferences regarding unrequested mail.

### 3. Data Integration

At block 515, the method may integrate the digital twin data with the existing user and address database. Ensure that the method may associate each real-world entity with its corresponding digital twin.

### 4. Machine Learning and Data Analysis

At block 520, the method may utilize machine learning algorithms and data analysis techniques to identify patterns and similarities among users or addresses based on their digital twin attributes. This may involve clustering algorithms, similarity measures, or collaborative filtering techniques.

### 5. Grouping Users/Addresses

At block 525, the method may group users or addresses with similar digital twin profiles may be grouped into clusters or segments. These clusters represent groups of users or addresses who share similar characteristics and likely have similar preferences regarding unrequested mail.

### 6. Predictive Modeling

At block 530, the method may train predictive models using the grouped data to forecast whether a user or address may be likely to opt-in or opt-out of unrequested mail. The method may use classification algorithms like logistic regression or decision trees.

### 7. Real-Time Data Updates

At block 535, the method may continuously update and refine the digital twins and predictive models as new user feedback and data become available. This ensures that the predictions remain accurate and up to date.

### 8. Recommendation Engine

At block 540, the method may implement a recommendation engine that suggests whether to send unrequested mail to a particular user or address based on their digital twin profile and predicted preferences. For instance, the engine might suggest sending promotional materials to users in clusters that have a high likelihood of opting in.

### 9. Feedback Loop

At block 545, the method may implement a feedback loop where user responses and feedback regarding unsolicited mail may be collected and used to update digital twin attributes and improve predictive models.

### 10. Privacy and Consent

At block 550, the method may ensure strict data privacy and consent policies may be in place, and that user data may be anonymized and protected throughout the process.

### 11. User Engagement

At block 555, the method may engage with users to inform them about the recommendation engine and provide an option to review and adjust their preferences at any time.

### 12. Compliance

At block 560, the method may ensure that the method comply with data protection regulations, especially when dealing with user data.

By creating digital twins and using data analysis and machine learning, the method may identify users or addresses with similar preferences regarding unrequested mail. This approach allows the method to make personalized decisions on whether to send unrequested mail, improving user satisfaction and reducing unwanted mail.

Logically, all these software elements may be embodied in separate physical elements which are specifically designed to execute the various software elements. For example, there may be servers for each function specifically designed for each function. The servers may be physically separate or may be combined onto one or more servers where the servers are adapted to maximize the services in question.

Additionally, certain embodiments may be described herein as including logic or a number of components, modules, blocks, or mechanisms. Modules and method blocks may constitute either software modules (e.g., code or instructions embodied on a machine-readable medium or in a transmission signal, wherein the code is executed by a processor) or hardware modules. A hardware module may be a tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” may be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” may refer to a hardware module. Considering embodiments in which hardware modules are temporarily configured (e.g., programmed), each of the hardware modules need not be configured or instantiated at any one instance in time. For example, where the hardware modules include a processor configured using software, the processor may be configured as respective different hardware modules at different times. Software may accordingly configure a processor, for example, to constitute a particular hardware module at one instance of time and to constitute a different hardware module at a different instance of time.

Hardware modules may provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

The methods or routines described herein may be at least partially processor implemented. For example, at least some of the operations of a method may be performed by one or processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification may be presented in terms of algorithms or symbolic representations of operations on data stored as bits or binary digital signals within a machine memory (e.g., a computer memory). These algorithms or symbolic representations may be examples of techniques used by those of ordinary skill in the data processing arts to convey the substance of their work to others skilled in the art. As used herein, an “algorithm” may be a self-consistent sequence of operations or similar processing leading to a desired result. In this context, algorithms and operations may involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, may be merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “embodiments,” “some embodiments” or “an embodiment” or “teaching” may mean that a particular element, feature, structure, or characteristic described in connection with the embodiment is included in at least one embodiment. The appearances of the phrase “in some embodiments” or “teachings” in various places in the specification may not necessarily all be referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments may not be limited in this context.

Further, the figures depict preferred embodiments for purposes of illustration only. One skilled in the art may be readily recognize from the following discussion that alternative embodiments of the structures and methods illustrated herein may be employed without departing from the principles described herein.

Upon reading this disclosure, those of skill in the art may appreciate still additional alternative structural and functional designs for the systems and methods described herein through the disclosed principles herein. Thus, while particular embodiments and applications have been illustrated and described, it is to be understood that the disclosed embodiments may not be limited to the precise construction and components disclosed herein. Various modifications, changes and variations, which may be apparent to those skilled in the art, may be made in the arrangement, operation and details of the systems and methods disclosed herein without departing from the spirit and scope defined in any appended claims.

1. A method to control the physical delivery of objects to a user at a property comprising:
accepting a unique code associated with a physical object to be delivered to a user;
verifying the code relates to the user;
displaying delivery options for one or more physical objects to the user in the future;
accepting user inputs related to the delivery options in the future;
storing the user inputs related to the delivery options in the future; and
communicating the user inputs related to the delivery options in the future to one or more senders of the physical objects.

2. The method of claim 1, wherein the objects are unrequested objects.

3. The method of claim 2, further comprising:
determining if an addressed related to the code is related to the physical address entered by a user;
in response to the determination being true;
allowing the user to use the method.

4. The method of claim 3, wherein verifying comprises decoding the code to be related a specific object.

5. The method of claim 4, wherein the unique code is an encrypted code.

6. The method of claim 1, wherein delivery options comprise at least one of: stop, forward, requesting more; requesting related materials; and requesting electronic communications.

7. The method of claim 1, further comprising:
analyzing the user inputs,
determining related physical objects to the delivered physical object,
requesting additional user inputs on the delivery of related physical objects;
storing the additional user inputs in a memory; and
communicating the additional user inputs to the sender of the related physical objects.

8. The method of claim 7, further comprising
creating a database of user inputs and additional user inputs;
accepting requests to determine users that desire the delivery of specific objects;
creating a list of users that desire the delivery of specific objects; and
communicating the list to senders of the specific object.

9. The method of claim 8, further comprising:
accepting requests to determine users that do not desire the delivery of specific objects;
creating a list of users that do not desire the delivery of specific objects; and
communicating the list to senders of the specific object.

10. The method of claim 1, wherein the code is QR code.

11. A computer system comprising a processor, a memory and input-output circuit, the processor physically configured according to computer executable instructions for controlling a physical delivery of objects to a user at a property, the instructions comprising computer executable instructions for:
accepting a unique code associated with a physical object to be delivered to an address;
verifying the code relates to the address;
displaying delivery options for one or more physical objects to the address in the future;
accepting user inputs related to the delivery options in the future;
storing the user inputs related to the delivery options in the future; and
communicating the user inputs related to the delivery options in the future to one or more senders of the physical objects.

12. The computer system of claim 11, wherein the objects may be unrequested objects.

13. The computer system of claim 12, further comprising instruction for:
determining if an addressed related to the code is related to the physical address entered by a user;
in response to the determination being true; allowing the user to use the method.

14. The computer system of claim 13, wherein verifying comprises decoding the code to be related a specific object.

15. The computer system of claim 14, wherein the unique code is an encrypted code.

16. The computer system of claim 10, wherein delivery options comprise at least one of:
stop, forward, requesting more; requesting related materials; requesting electronic communications.

17. The computer system of claim 10, further comprising computer instructions for:
analyzing the user inputs,
determining related physical objects to the delivered physical object,
requesting additional user inputs on the delivery of related physical objects;
storing the additional user inputs in a memory; and
communicating the additional user inputs to the sender of the related physical objects.

18. The computer system of claim 16, further comprising computer instructions for:
creating a database of user inputs and additional user inputs;
accepting requests to determine addresses that desire the delivery of specific objects;
creating a list of address that desire the delivery of specific objects; and
communicating the list to senders of the specific object.

19. The computer system of claim 18, further comprising computer instructions for:
accepting requests to determine addresses that do not desire the delivery of specific objects;
creating a list of addresses that do not desire the delivery of specific objects; and
communicating the list to senders of the specific object.

20. The computer system of claim 10, wherein the code is QR code.
